(19) United States
(12) Patent Application Publication
(10) Pub. No.: US 2010/0310711 A1
(43) Pub. Date: Dec. 9, 2010

(54) MILK FILTRATION SYSTEM

(76) Inventor: Lamar Chet KENDELL, REXBURG, ID (US)

Correspondence Address: DYKAS & SHAVER LLP, P.O. BOX 877, BOISE, ID, 83701-0877, US

(21) Appl. No.: 12/795,500

(22) Filed: Jun. 7, 2010

Related U.S. Application Data
(60) Provisional application No. 61/185,138, filed on Jun. 8, 2009.

(51) Int. Cl. A01J 5/007; A01J 11/06

(52) U.S. Cl. 426/2; 210/416.1; 210/149; 210/412; 210/411; 210/323.1; 210/85

(57) ABSTRACT

A method and apparatus for microfiltering milk before the milk is allowed to cool is disclosed that removes bacteria and other filtrates from the milk thus producing a microfiltered milk product.

### PRIORITY/CROSS-REFERENCE TO RELATED APPLICATIONS

This application claims the benefit of U.S. Provisional Application No. 61/185,138, filed Jun. 8, 2009, the disclosure of which is incorporated by reference.

### TECHNICAL FIELD

The presently disclosed and claimed inventive concepts generally relate to an apparatus for filtering milk, a method for filtering milk, and a filtered milk product, and more particularly to a novel method of microfiltering milk to remove bacteria and other material from milk, an apparatus for microfiltering milk, and a microfiltered milk product.

### BACKGROUND

Typically milk is drawn from the cow then stored in a bulk tank on the farm where it is cooled and agitated for several days while waiting to be transferred via a milk tank truck to a central dairy processing facility. Once in the central processing facility, the milk is pooled, heated (pasteurized), separated into components if desired, homogenized, bottled and refrigerated. From the central processing facility the bottled milk is then distributed to various retail outlets. This process takes at least four to six days from the time the milk is drawn until it is available for retail consumption.

Pasteurization is a process which slows microbial growth in foods. The process was named after its creator, French chemist and microbiologist. The first pasteurization test was completed by Louis Pasteur and Claude Bernard on Apr. 20, 1862. The process was originally conceived as a way of preventing wine and beer from souring.

Unlike sterilization, pasteurization is not intended to kill all pathogenic microorganisms in the food or liquid. Instead, pasteurization aims to reduce the number of viable pathogens so they are unlikely to cause disease (assuming the pasteurization product is refrigerated and consumed before its expiration date). Commercial scale sterilization of food is not common because it adversely affects the taste and quality of the product.

Pasteurization typically uses temperatures below boiling since at temperatures above the boiling point for milk, casein micelles will irreversibly aggregate (or “curdle”). There are two main types of pasteurization used today: High Temperature/Short Time (HTST) and Extended Shelf Life (“ESL”) treatment. Ultra high temperature (UHT or ultra heat treated) is also used for milk treatment. In the HTST process, milk is forced between metal plates or through pipes heated on the outside by hot water, and is heated to 71.7° C. (161° F.) for 15-20 seconds. UHT processing holds the milk at a temperature of 138° C. (280 of) for a fraction of a second. Milk simply labeled “pasteurized” is usually treated with the HTST method, whereas milk labeled “ultra pasteurized” or simply “UHT” has been treated with the UHT method.

Extended shelf life milk is also produced using a heating process in which the milk is preheated to 70° C.-85° C. and then heated to a maximum temperature of 127° C. by direct steam injection for approximately 3 seconds and is then cooled down to 70° C.-85° C. in a flash cooler. ESL milk also is subjected to microfiltration. For the microfiltration process, ceramic membranes with pore sizes of 0.8 ˜m-1.4 ˜m are used. Prior to microfiltration, the raw milk is preheated and then cleaned and skimmed in the separator. The skim milk is then microfiltered at skimming temperature. After high-heat treatment the cream is mixed with the skim milk and homogenized in a separate stream. The standardized milk is pasteurized in the milk heat exchanger, then cooled down to 4-6° C. and made available for filling.

Pasteurization methods are usually standardized and controlled by national food safety agencies (such as the USDA in the United States and the Food Standards Agency in the United Kingdom). These agencies require milk to be HTST pasteurized in order to qualify for the “pasteurized” label. There are different standards for different dairy products, depending on the fat content and the intended usage. For example, the pasteurization standards for cream differ from the standards for fluid milk, and the standards for pasteurizing cheese are designed to preserve the phosphatase enzyme, which aids in cutting.

The HTST pasteurization standard was designed to achieve a 5-log reduction, killing 99.999% of the number of viable micro organisms in milk. This is considered adequate for destroying almost all yeasts, mold, and common spoilage bacteria and also to ensure adequate destruction of common pathogenic heat resistant organisms (including Mycobacterium tuberculosis, which causes tuberculosis and Coxiella burnetii, which causes Q fever). HTST pasteurization processes must be designed so that the milk is heated evenly, and no part of the milk is subject to a shorter time or a lower temperature.

Due to the heating of the milk during pasteurization, the taste of the milk is adversely affected. Pasteurization also causes degradation of the milk enzymes and proteins. In addition, the pasteurization process does not kill all of the bacteria but simply reduces the amount of live bacteria present in the milk. Eventually these bacteria perpetuate and spoil the milk. Finally, all of the bacteria that was present in the milk, live or dead, remains in the milk, including all residual dead microorganisms. Pasteurization typically requires large scale central processing and is thus capital intensive. Pasteurization typically results in at least a three day delay in the time it takes to get the milk to market.

Microfiltration is a filtration process which removes contaminants from a fluid (liquid or gas) by passage through a microporous membrane. A typical microfiltration membrane pore size range is 0.1 to 10 micrometers (˜m). Microfiltration is not fundamentally different from reverse osmosis, ultrafiltration or nanofiltration, except in terms of the size of the molecules it retains.

Developed by Professor Zsigmondy University of Goettingen, Germany, in 1935, membrane filters were first commercially produced by Sartorius GmbH a few years later. Membrane filters found immediate application in the field of microbiology and in particular in assessment of safe drinking water. Further development of microfilters in the mid 1970s led by the United States Food and Drug Administration requirement for non fiber releasing filters to be used in the production of injectable solutions. Membrane filters are widely used in biotechnology and food and beverage applications.

Increasingly used in drinking water treatment, microfiltration effectively removes major pathogens and contaminants such as Giardia lamblia cysts, Cryptosporidium oocysts, and large bacteria. For mineral and drinking water bottlers, the most commonly used format is pleated cartridges usually made from polyethersulfone (PES) media. This media is asymmetric with larger pores being on one side and smaller pores being on the other side of the filter media. Another type of microfilter known in the art is a ceramic filter, for example such as those sold by the Pall Corporation under the MEMBRALOX mark or ceramic filters made by the Doulton Company.

Microfiltration membranes were first introduced to the municipal water treatment market in 1987 and applied primarily to waters that were relatively easy to treat. These were cold, clear source waters that were susceptible to microbial contamination. Low pressure membranes were selected to remove turbidity spikes and pathogens without chemical conditioning. As low pressure membranes increased in acceptance and popularity, users began to apply the technology to more difficult waters which contained more solids and higher levels of dissolved organic compounds. Some of these waters required chemical pretreatment, including pre chlorination. These shifts in water quality triggered change in low pressure membrane technology. New products and processes were introduced to deal with higher solids and chemical compatibility.

The use of microfiltration methods have not been readily employed in the purification of milk because of the fat content that is present in milk. More specifically, due to the presence of fat solids in milk, microfiltration has been unsuccessful. The fat solids tend to quickly clog the micro filters and rapidly reduce the ability of the micro filters to continue to filter microparticles, such as bacteria. In addition, the fat molecules tend to be larger in size than the microorganisms and thus larger than the pores of the micro filter, which results in the fat solids effectively plugging the pores of the filter so that the filter quickly loses its filter properties. The problem is compounded by delayed processing, agitation and bulk tank refrigeration.

In recent years significant improvements have been made both in filtration and refrigeration technology. Filtration is a viable option to pasteurization. Many fluid products that were once exclusively pasteurized, such as beer and wine, are now filtered. At the same time refrigeration technology has become commonplace. The filtration of milk has been problematic as milk fat molecules become clumped together and become larger in the milk with time and agitation. With refrigeration milk fat molecules become a solid. In essence the current method of processing milk begins to make butter in the bulk tank. By the time the milk gets to the central processing facility the milk fat molecules are larger than the bacteria and a solid as well. Filtration of whole milk is impractical as the filters soon become clogged with the large milk fat molecules.

There have been attempts to overcome this problem by separating the milk fat from the whole milk and filtering just the skim milk. Reference U.S. Pat. No. 4,876,100. The milk fat can then be pasteurized and added back to the skim milk and homogenized. This process has not been adopted into general use as it is difficult to separate out all the milk fat and the filter eventually becomes clogged with the residual milk fat. This process is also inefficient as it adds additional costly dual processing steps.

### SUMMARY OF THE DISCLOSURE

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concepts of the application, which is measured by the claims, nor is it intended to be limiting as to the scope of the inventive concepts in any way.

In accordance with the invention, there is provided an apparatus and associated method for the microfiltration of milk in order to remove microorganisms as an alternative to pasteurization. The filtration of whole milk becomes viable if the point of filtration takes place immediately after the milk is drawn from the cow, because at that point the fat molecules are small, dispersed and warm; meaning in a liquid state. The invention is a closed system in a preferred embodiment, eliminating the potential of bacterial ingress.

In a preferred embodiment, the apparatus has milk drawing, filtration, refrigeration and filling components. The apparatus may be integrated into a single unit or comprise several separate systems that work in series to produce a raw milk product with significantly reduced bacterial count. In a preferred embodiment, the apparatus also has the capacity to electronically store the milk processing parameters to facilitate off site verification of the integrity of the milk quality and allow the parametric release of the filled milk.

In a preferred embodiment of the present invention the invention includes a method of microfiltering milk. The method is comprised of the steps of milking an organism, microfiltering the milk through a milk microfilter while the milk is at a temperature approximate to the body temperature of the organism that produced the milk, chilling the milk, and filling the milk into a retail container or other type of storage container. This method can also include the step of maintaining the milk at a temperature approximate to the body temperature of the organism that produced the milk until the milk is microfiltered. This can be done using, for example, a heat exchanger that maintains the warmth of the milk. In a preferred embodiment of the invention, the milk microfilter has a pore size of 1.6 microns or less in order to filter microorganisms and other filtrate out of the milk. In a preferred embodiment, the milk microfilter has a pore size of 1.4 microns or less in order to filter microorganisms and other filtrate out of the milk. In a preferred embodiment of the invention, the microfiltering of the milk occurs at a location where the milking of the organism occurred in order to filter the milk before the fat molecules coalesce into globules that are too large to pass through the filter.

An apparatus for practicing a preferred embodiment of the current invention is also provided. In a preferred embodiment, the apparatus has at least one milking attachment for drawing milk from an animal. A pump draws the milk from the milk producing organism and subsequently pumps the milk or draws the milk through the milk microfilter. This microfilter in a preferred embodiment has a pore size of 1.6 microns or less. In another preferred embodiment, the milk microfilter has a pore size of 1.4 microns or less. In a preferred embodiment, the apparatus is configured such that milk is drawn from the organism, pumped or drawn through the milk microfilter, and subsequently chilled and filled into a retail type container. While a retail type container is provided in a preferred embodiment, the milk likely can also be filled into basically any container and subsequently transported to another site or filled on site into retail containers.

The apparatus in a preferred embodiment has at least one warming device that maintains the warmth of the milk after the milk is drawn from the milk producing organism and prior to and possibly up to the point of filtration. The warming device is optional and may not be necessary if milk can be filtered before the milk fat molecules coalesce. This assists in preventing the milk fat molecules from coalescing into a size that prevents them from passing through the filter and thus clogging the filter.

In a preferred embodiment, the milk microfilter comprises a dead end microfilter. In a preferred embodiment, the milk microfilter comprises a pass through milk microfilter in which milk is circulated throughout the system and milk is drawn through the filter or pumped through the filter via one or more pumps. Milk that is not drawn through or pumped through the filter is circulated in the system and passes by the pass through filter again whereupon more of the milk is filtered through the pass through filter. In a preferred embodiment, the milk filtration system of the present invention is a closed system in order to prevent contamination from outside sources.

In a preferred embodiment the apparatus has a pulse device that is configured to back pulse air onto, for example, a plunger device or a diaphragm device that forces milk filtrate that has become trapped in and/or on the filter to dislodge. In a preferred embodiment, in a pass through filter system the dislodged filtrate circulates back through the apparatus. In a preferred embodiment, up to 6 bar of pressure forces the plunger device or diaphragm device to flex and place pressure onto the filter to dislodge any trapped material. In a preferred embodiment, the back pulse operates every five seconds while milk is being filtered. In a preferred embodiment, the back pulse device is configured to back pulse at intervals between timed such that the pump or pumps of the system are not drawing and/or pumping milk at the time of back pulse.

In a preferred embodiment the apparatus has a back flush in which a liquid is back flushed through the filter in order to dislodge filtrate trapped in the filter. In a preferred embodiment, the back flush device is configured to back flush the system when the system is not in the process of milking an organism and filtering the milk, e.g., in between milking of individual organisms such as bovines when there is no organism attached to the apparatus. In a preferred embodiment, the back flush system has a filter that filters the liquid that is used to back flush the microfilter before the liquid back flushes the microfilter. In a preferred embodiment, the back flush system back flushes heated water at approximately 160 degrees F. to back flush the system. In a preferred embodiment, the filter on the back flush system has a pore size of one micron. Alternatively, the system can comprise both a pulse device and a black flush.

In a preferred embodiment, the apparatus has a second microfiltration system that is configured such that milk not passing through the pass through microfilter is microfiltered by a second microfilter. This second microfilter can comprise either a dead end filter or a pass through filter.

In a preferred embodiment, the apparatus has at least two pumps which pump and draw milk. One of the pumps in a preferred embodiment is on the upstream side of the apparatus between the milking apparatus and the filter. This pump draws milks from the organism being milked and can also pump milk across the filter. In a preferred embodiment, a second pump is located at a point downstream from the filter between the filter and the filling or exit point of the apparatus. This pump can be configured to draw milk across the filter and possibly to pump milk to the exit point or the filling point of the system. In a preferred embodiment, the pumps of the system are peristaltic pumps that can be configured to pump milk in synchronous timing or in asynchronous timing. In a preferred embodiment, one of the pumps draws milk, preferably the pump upstream from the milk microfilter, while the second pump pumps milk throughout the system.

In a preferred embodiment, the apparatus has one or more devices such that the internal physical conditions of the apparatus can be monitored. These internal physical conditions include the temperature and/or pressure of the apparatus. In a preferred embodiment, one internal condition monitoring device is at a position point upstream of the filter between the milking and the milk microfilter. In a preferred embodiment, an internal condition monitoring device is positioned at a point downstream of the milk microfilter between the milk microfilter and the exit point or filling point of the apparatus. The output measurements of the internal condition monitoring devices can be recorded manually or produced in a computerized or digital format such that the measurements can be used to maintain and asseses the quality and function of the apparatus.

In a preferred embodiment, the apparatus for microfiltration may utilize a peristaltic pump which draws the milk from the cow or other milk source using conventional teat cups or other devices. The pump also pressurizes the upstream side of the filter assembly. The system also provides temperature control; both pre and post filter(s) assembly. In a preferred embodiment, warm water circulates through the assembly to maintain the temperature of the milk at approximately body temperature, which may be in the range of about 37 degrees C., plus or minus approximately 10 degrees C., until the milk is filtered. In a preferred embodiment, the milk is not allowed to cool below the body temperature of the organism being milked as cooling likely will lead to coalescence of the milk fat molecules and increased difficulty in microfiltering the milk. A micro filter may include one or more prefilters. In a preferred embodiment, the primary micro filter is capable of removing bacteria. In a preferred embodiment, pressure sensors before and after the filter verify the filter integrity to maintain quality control of the apparatus.

In a preferred embodiment, a second peristaltic pump generates a vacuum on the downstream side of the filter assembly to draw milk across the filter. In a preferred embodiment, the second pump also places fluid pressure on the milk through the remainder of the apparatus. An inline milk chiller reduces the temperature of the milk to cold storage temperature, which may be about 3 degrees C. but likely in practice will be around 4 or 5 degrees C. A milk filling machine dispenses the milk into retail containers. The filling machine controls are integrated to synchronize the milking and filling rates as well as on/off control of the peristaltic pump. In a preferred embodiment, a data recorder retains key processing parameter: filter pressures, quantity filled, time events, and is accessible via modem or other means of communication, in real time, to milk quality inspectors.

The apparatus is used in combination with a method of filtering milk in which filtration takes place immediately after drawing the milk. To limit subsequent bacterial contamination, the milk is promptly chilled and filled in its final retail container. Alternatively, subsequent processing such as homogenization or separation of milk components would be possible before filling if conducted in a closed system.

In the preferred embodiment, the point of processing is deliberately changed from a large centralized facility to smaller, dairy farming systems that would, typically, be locally supported. The method to filter, chill and fill at the farm level, would be significantly simpler and quicker resulting in much fresher whole milk with a longer shelf life.

Still other features and advantages of the presently disclosed and claimed inventive concepts will become readily apparent to those skilled in this art from the following detailed description describing embodiments of the inventive concepts, simply by way of illustration of the best mode contemplated by carrying out the inventive concepts. As will be realized, the inventive concepts is capable of modification in various obvious respects all without departing from the inventive concepts. Accordingly, the drawings and description of the embodiments are to be regarded as illustrative in nature, and not as restrictive in nature.

### BRIEF DESCRIPTION OF THE DRAWINGS

FIG. 1 is a schematic illustration of a milk drawing and filtration system having a dead end microfilter in accordance with the principles of the present invention.

FIG. 2 is a schematic illustration of a milk drawing and filtration system having a pass through microfilter in accordance with the principles of the present invention.

FIG. 3 is a schematic illustration of a valving system for directing the flow of fluids through the microfilter of the milk drawing and filtration system in accordance with the principles of the present invention.

FIG. 4 is a schematic illustration of an embodiment of the valve system of the back flush of an embodiment of the present invention.

FIG. 5 is a schematic illustration of an embodiment of the valve positions associated with the back flush of the current invention.

### DETAILED DESCRIPTION OF THE EXEMPLARY EMBODIMENTS

While the presently disclosed inventive concepts is susceptible of various modifications and alternative constructions, certain illustrated embodiments thereof have been shown in the drawings and will be described below in detail. It should be understood, however, that there is no intention to limit the inventive concepts to the specific form disclosed, but, on the contrary, the presently disclosed and claimed inventive concepts is to cover all modifications, alternative constructions, and equivalents falling within the spirit and scope of the inventive concepts as defined in the claims.

In the following description and in the figures, like elements are identified with like reference numerals. The use of “e.g.,” “etc,” and “or” indicates non exclusive alternatives without limitation unless otherwise noted. The use of “including” means “including, but not limited to,” unless otherwise noted.

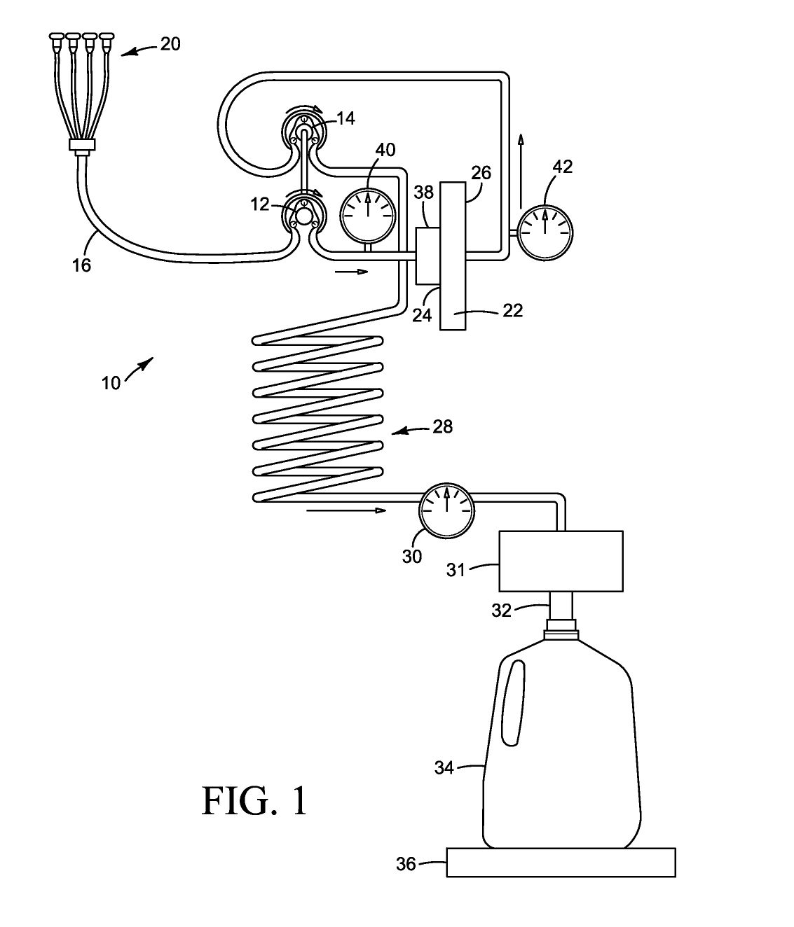

FIG. 1 illustrates a preferred embodiment of a milk extraction and microfiltration system, generally indicated at 10, in accordance with the principles of the present invention. The system 10 includes a pair of peristaltic pumps 12 and 14 coupled to line 16. Line 16 is coupled to a milking harness 20 configured for attachment to the udder of a milking cow. The peristaltic pump 12 draws a vacuum on line 16 to, in turn, cause a suction on the attached cow or other organism being milked (not shown). When a calf nurses its mother it naturally uses a peristaltic action to draw the milk, therefore, the use of a peristaltic pump more closely conforms to the sucking action of a calf. Thus, the use of peristaltic pump 12 provides a built in oscillator to vary the suction action at each cycle of the peristaltic pump 12. Such pumps can also be configured to have a variable speed to accommodate flexibility in the milking process. The pumps 12 and 14 can also be put in reverse in order to back flush and sanitize the system after use. The pumps 12 and 14 are connected in series such that a single motor can drive both pumps. In a larger scale system with multiple milking harnesses 20, a plurality of such pumps may be linked in series to be operated by a single drive motor. It is also contemplated that each milking station, which would include the harness 20, the filter 22 and the pumps 12 and 14, could be individually controlled by monitoring the milk flow from the cow and the pump rate customized according to the milk production characteristics of the cow. The milking harness 20 can be a conventional milking harness known in the art.

In a preferred embodiment, the second peristaltic pump 14 is situated downstream of the filter 22. While the first pump 12 draws milk from the cow and pressurizes the front side 24 of the filter 22, the second pump 14 draws a vacuum on the back side 26 of the filter 22. In order to ensure that the filter is functioning properly, pressure sensors 40 and 42 are provided on opposite sides of the filter 22 to monitor the differential pressure/vacuum of the milk in the process lines. If the pressure on sensor 40 begins to increase and the vacuum on sensor 42 increases, the user can be alerted that the filter is clogging and that filter cleaning or replacement may be needed. Conversely, if a rapid drop in pressure at sensor 40 occurs simultaneously with a drop in vacuum at sensor 42, it would indicate a ruptured filter. The pressurized milk is then sent through a refrigeration unit 28, such as an in line chiller. The flow of milk, once cooled, is monitored by a flow meter 30 as the milk is dispensed through a filling nozzle 32 and into a retail milk container 34. A scale 36 upon which a container 34 resides during filling tells the filling equipment when the container 34 is full. The containers 34 may be manually attached to the filling nozzle 32 or automatically, as may be provided by automated filling equipment.

The filter 22 comprises a micro filter capable of removing microorganisms from raw milk. For example, a Pall Corporation 1.4 micron filter may be employed to remove microorganisms that are larger than 1.4 microns. Likewise, a Pall Corporation MEMBRALOX ceramic filter may be employed, which can be configured to provide microfiltration of between 0.1 to 12 microns as desired.

Such filters are available as high capacity pleated filters and with multi stage pre filters. These filters can be back flushed, sanitized and reused. Use of microfiltration according to the present invention yields filtered milk thought to be acceptable by societal standards by removing sufficient microorganisms from the milk to be considered safe for retail sale.

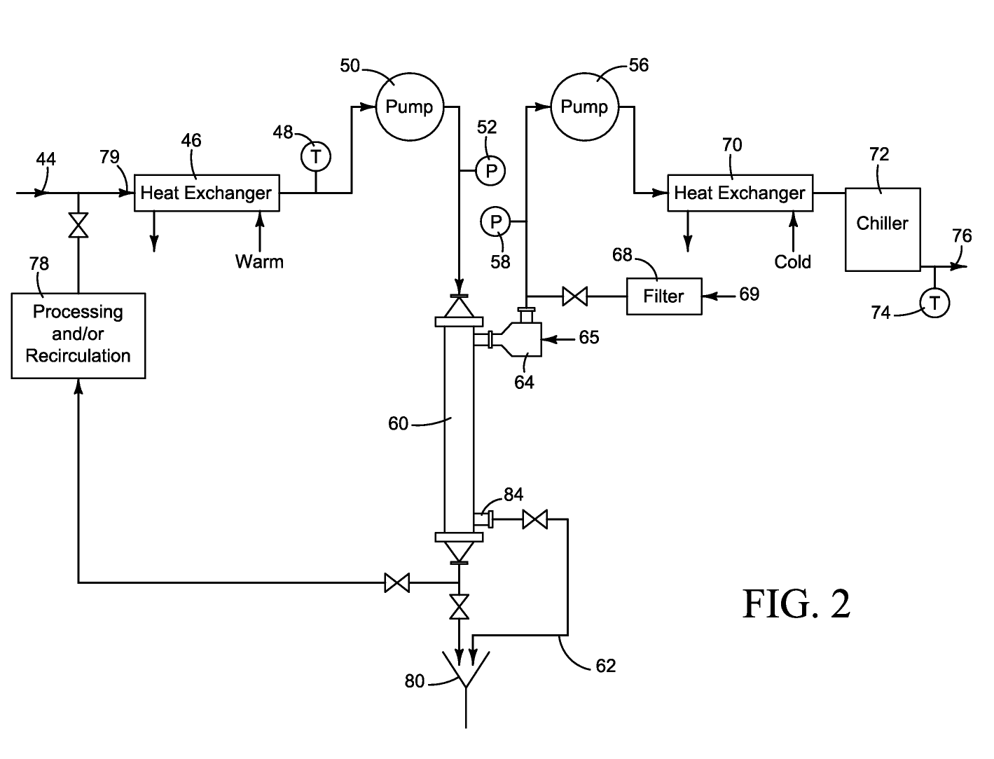

FIG. 2 represents a diagram of an embodiment of the apparatus of the invention that includes a pass through microfilter. In the figure, milk enters the apparatus at point 44 which is typically a milking apparatus. In the depicted embodiment, a heat exchanger 46 provides an optional mechanism for maintaining the warmth of the milk at the approximate body temperature of the organism that provided the milk. A temperature gauge 48 can be provided to monitor the temperature of the milk to ensure, for example, the correct temperature of the milk and to ensure the apparatus is functioning correctly. A pump 50 is provided to pump milk through the system as well as to increase milking effectiveness of the system. In the depicted embodiment, the pump 50 is a peristaltic pump as described above. The overall system can be configured to have a pressure sensor 52 that portrays a measurement of the internal pressure of the overall system or of parts of the system to provide a mechanism for monitoring the function of the apparatus. The milk is pumped from the milking apparatus or entry point of the milk 44 to the milk filter 60. In the embodiment of the apparatus depicted in FIG. 2, the milk filter 60 is a pass through milk filtration apparatus in which milk is circulated from the pump 44 through the milk filter 60. Milk that is filtered is drawn and or pumped through the filter 60 by way of the pump 56 sucking the milk through the filter and towards the final destination in the apparatus of the milk. In a preferred embodiment, milk that does not pass through the membrane continues recirculation through the apparatus as depicted by the recirculation diagram box 78. Alternatively, milk that is not pumped through the membrane of the filter could also be pumped either to drain 80 or can be pumped to a second filter apparatus via pump 84, depending on the embodiment of the system.

In the depicted embodiment, milk that passes through the membrane of the filter passes through the filter and on to pump 56 and subsequently is cooled via optional heat exchanger 70 and chilled by the milk chiller 72. In a preferred embodiment, between the milk filter and the milk pump, a pressure gauge 58 can be installed that monitors the pressure of the overall apparatus that can function as a quality control and to ensure the apparatus is functioning properly. A temperature gauge 74 can also be installed in order to monitor the temperature of the milk after the milk is chilled. This will ensure proper temperature of the milk before it is filled into the final packaging or into transport or storage packaging. FIG. 2 illustrates back pulse device 64 which is typically a plunger or diaphragm type device in which air is forced as indicated by arrow 65 to cause movement of the plunger or diaphragm to operate in a pulsating manner. Reference number 64 also indicates where the milk flows when proceeding from the filter 60 en route to exiting the apparatus. Reference number 64 also indicates the location of a backflow device, if the apparatus is equipped with one, in which a liquid, preferably heated water, flows 69 through a filter 68 and on to backflush the filter 60.

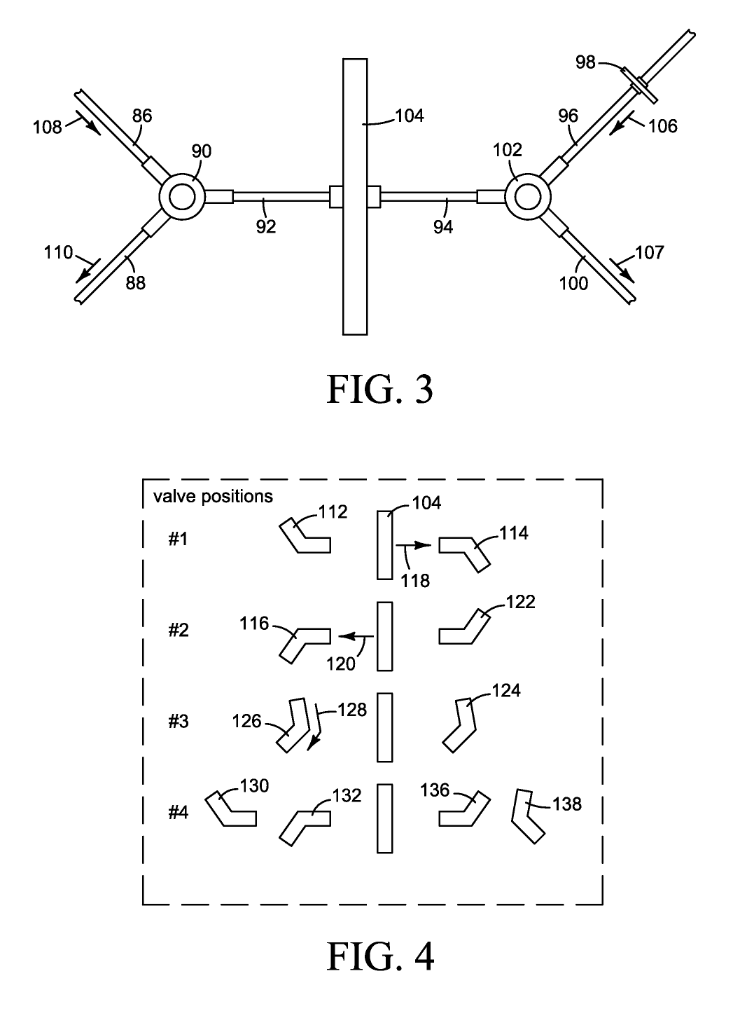

FIG. 3 and FIG. 4 illustrate a valve system for use in controlling the flow of fluids relative to the microfilter. The valves are inserted between the milk microfilter and the peristaltic pumps. Milk travels from the first pump via conduit 86 to a first valve 90. The first valve 90 is inserted between the first pump and the microfilter and can be configured to allow milk to travel via conduit 92 to the filter or via conduit 88 to the drain. The valves illustrated in FIG. 3 can be a wide range of valves, whether three way valves, a series of one way valves, T-valves, or any other valve system or combination to one of skill in the art. FIG. 3 indicates the milk can flow into and through the filter as illustrated by arrows 108 and 107 to a filing device, the organism can be milked to drain via arrows 108 and 110, or backflush liquid can enter and backflush the system as indicated by arrows 106 and 110. The valve can be operated to direct milk from the first pump to the micro filter 112 (see e.g., valve position #1 of FIG. 4) or to a drain 116, 126, 132 (see, e.g., valve position #3 of FIG. 4). In a back flush operation, the first valve can be operated to allow flow in an opposite direction through the filter and out to the drain (see e.g., valve position #2 of FIG. 4). Also, in a sanitizing mode of operation, the valve can be operated to allow a sanitizing fluid, such as hot water, to flow to the first pump or out through the drain (see e.g., valve position #4 of FIG. 4). The second valve can be operated to allow milk flowing from the filter to flow to the second pump 114 (see e.g., valve position #1 of FIG. 4) or to allow back flushing 122 (see e.g., valve position #2 of FIG. 4) or sanitizing of the system (see e.g., valve positions #4 of FIG. 4) as shown in line coming from the first pump. If the cow is being milked to a drain (as may be the case if a cow picks up an infection of the udder and the increased bacterial count quickly plugs the filter at which time it may be desirable to simply milk the cow to the drain 126, 124 (see e.g., valve positions #3 of FIG. 4). As such, in a preferred embodiment the valving system of the present invention allows the flow of milk to be diverted from the filter if necessary and also to allow back flushing of the filter to a drain as well as complete sanitation of the system.

Referring again to FIG. 1, the refrigeration system 28 may employ a standard in line chiller with the size dependent upon the number of cows being milked at one time and thus the quantity of milk being produced. The heat discharged from the chiller can be utilized to a heat exchanger 38 in order to maintain the raw milk at approximately body temperature, which may be about 37 degrees C., plus or minus 10 degrees, until the milk has been filtered. In a preferred embodiment, the temperature of the milk is maintained at a temperature such that milk fat molecules are not allowed to significantly coalesce into globules that are predominantly larger than the pore size of the microfilter. In a preferred embodiment, the pore size of the microfilter is selected such that the pores filter harmful microorganisms and other harmful filtrate from the milk while allowing as much of the milk to pass through the filter as possible. The heat exchanger 38 is positioned prior to the microfilter 22 to ensure that the milk entering the microfilter 22 is being maintained at an optimum temperature (e.g., the approximate body temperature of a cow or 37 degrees C. plus or minus 10 degrees) that helps maintain the size of the milk fat particles entering the microfilter 22 so as to limit plugging of the microfilter 22 during the filtration process. The heat exchanger 38 may be a separate unit that is coupled in line between the first pump 12 and the microfilter 22 or incorporated into the filter housing. The temperature of the system is maintained, in a preferred embodiment, at a temperature that minimizes fat molecule coalescence into large globules. The same discussion of heat exchangers and coolers applies to FIG. 2 as well.

The filling system could be either large scale or small scale, depending on the needs of the milk producer. Positive discharge, tank less filling technology could be employed. An automated system could provide a preset shut off by scale weight with automatic indexing to the next unfilled container. The system could also provide automatic on/off control of the pumps 12 and 14 as well as automatic or semi manual capping, label placement and lot numbering.

The method of milk drawing and filtration according to the present invention is thought to be completely verifiable and thus should be acceptable by the USDA and the FDA.

In a preferred embodiment, key process variables, such as filter integrity, can be monitored by monitoring pressures before and after the filter as well as quantity filled and filling times. In a preferred embodiment, all such data is recorded on a data chip or in computer memory and available in real time via modem or other means of data transmission or communication to a local health inspector.

One of the fastest growing dairy markets involves the sale of products directed to customers typically identified as cultural conservatives. The present invention has particular marketability to such consumers. Such consumers are generally concerned with local business and culture, hold conservative values, are price conscious but not wholly motivated thereby and are independently thinking and acting. Because milk produced according to the method and apparatus of the present invention is done so with little, if any, processing or chemical additions and available immediately after chilling, such cultural conservatives will have a great interest in purchasing such a product.

Another benefit of the apparatus is that it could be portable. A historical problem with conventional milking and milk processing methodologies is that it is difficult for dairymen who primarily graze their cows on pastures to provide enough good feed for their cows in close proximity to fixed central milking stations and processing facilities. Generally speaking, these cows spend their time traveling to and from the milking station rather than eating. The invention would alleviate this problem.

The system for milking according to the present invention, such as the embodiment of the system 10 shown in FIG. 1 or the embodiment presented in FIG. 2, can be provided in a small, portable, integrated milking, microfiltration, in line chilling and filling station in the field, such as in an enclosed trailer or integrated into a milking station vehicle. Such a system would be relatively inexpensively constructed using the following components: a pump with two heads, a chiller, a filler, a data storage device, a cabinet and miscellaneous hardware. Such components are relatively inexpensive compared to conventional milking and pasteurization equipment. As such, a milk producer could produce milk at less cost than is currently available.

Of course, the system for filtering milk according to the present invention could be scaled to any relative size depending on the needs of the dairy farmer. In addition, each of the various subsystems of the invention could be independently operated in a series. For example, the dairy farmer could draw the milk from the cow into a heated holding tank that would maintain the milk at a desired temperature until the milk is delivered to the microfiltration system. After microfiltration, the milk could then be transported to a chilling system to cool the milk prior to being bottled.

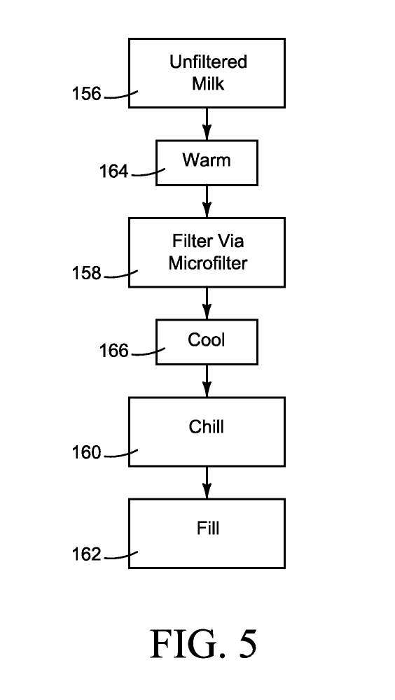

FIG. 5 depicts a diagram of the method of microfiltering milk of an embodiment of the present invention. Milk is drawn from an organism 156, filtered via a microfilter 158 while the milk is still warm, and subsequently cooled and/or chilled 160 and eventually filled 162 into a container for retail. The method can optionally include the step 164 of maintaining the milk at the approximate body temperature of the organism producing the milk. The step of maintaining the milk at the approximate body temperature of the organism producing the milk is largely dependent on whether the Additionally, the method optionally can include the step 160 of cooling the milk from the approximate body temperature of the animal producing the milk towards the temperature for chilling the milk.

Accordingly, the present invention provides a method and apparatus for filtering bacteria and other small microorganisms and/or contaminants from milk by employing a microfiltration process. The microfiltration process preferably occurs immediately after milking while the milk is still warm and the fat particles in the milk are dispersed and have not coalesced to form larger fat solids. In addition, because the milk is still warm, the fat molecules are warm and in a liquid state. Microfiltration of the milk immediately after milking allows the micro filter to remove live bacteria from the milk while allowing the fat molecules in the milk to pass through the micro filter. Alternatively, if filtration is not possible immediately after milking, the milk can be kept warm to prevent significant milk fat coalescence that has the capability to clog the milk filter.

While certain exemplary embodiments are shown in Figures and in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

What is claimed is:

1. A method of microfiltering milk, said method comprising the steps of:
milking an organism;
microfiltering said milk through a milk microfilter while said milk is at a temperature approximate to the body temperature of the organism that produced said milk;
chilling said milk; and
filling said milk into a retail container.

2. The method of claim one, wherein said method further includes the step of maintaining said milk at a temperature approximate to the body temperature of the organism that produced said milk until said milk is microfiltered.

3. The method of claim 1, wherein said milk microfilter comprises a pore size of 1.6 microns or less.

4. The method of claim 3 wherein said milk microfilter comprises a pore size of 1.4 microns.

5. The method of claim 1 wherein said microfiltering of said milk occurs at a location at which said milking of said organism occurred.

6. The method of claim 1 wherein said microfiltering of said milk occurs before said milk cools below a point within ten degrees of the body temperature of said animal producing said milk.

7. An apparatus for microfiltering milk, said apparatus comprising:
at least one milking attachment configured for attachment to a milk producing organism and configured for drawing milk from said milk producing organism;
at least one pump configured to pump milk from said at least one milking attachment through at least one milk microfilter and to an exit location of said apparatus through at least one transport conduit;
wherein said milk microfilter is positioned and configured such that milk is pumped by said pump from said milking apparatus through said milk microfilter while said milk is at a temperature approximate to a body temperature of an organism being milked, wherein said apparatus is configured such that microfiltered milk flows from said milk microfilter to said exit location.

8. The apparatus of claim 7, wherein said apparatus further comprises at least one device configured for maintaining said milk at approximately the body temperature of said organism that produced said milk until said milk is microfiltered.

9. The apparatus of claim 7 wherein said milk microfilter of said apparatus comprises a dead end milk microfilter.

10. The apparatus of claim 7 wherein said milk microfilter comprises a pass through milk microfilter, wherein said system comprises at least one transport conduit that is configured to transport milk from said pass through milk microfilter to a point in said transport conduit between said milking apparatus and said pass through milk microfilter.

11. The apparatus of claim 7 wherein said apparatus comprises a pulse device configured to back pulse the microfilter of said apparatus.

12. The apparatus of claim 7 wherein said apparatus comprises a back flush wherein said back flush is configured to back flush said milk microfilter with a liquid to remove filtrate trapped in said milk microfilter when said apparatus is not filtering milk.

13. The apparatus of claim 12 wherein said back flush system comprises a filter configured for filtering said liquid before said liquid back flushes said milk microfilter.

14. The apparatus of claim 10 wherein said apparatus comprises a second microfiltration system configured such that milk not passing through said pass through milk microfilter is microfiltered by a second milk microfilter.

15. The apparatus of claim 7 wherein said apparatus comprises at least two pumps, wherein at least one of said pumps is located at an upstream location of said apparatus from said milk microfilter, wherein the upstream pump is configured to pump milk from said milk producing organism into said apparatus via said milking attachment, wherein at least one of said pumps is located at a downstream location of said apparatus from said milk microfilter.

16. The apparatus of claim 15 wherein said pumps comprise peristaltic pumps configured to pump milk in synchronous timing.

17. The apparatus of claim 7 wherein said milk microfilter comprises a pore size of 1.6 microns or less.

18. The apparatus of claim 7 wherein said milk microfilter comprises a pore size of 1.4 microns.

19. The apparatus of claim 7 wherein said apparatus comprises at least two internal condition monitoring devices positioned and configured for providing a measurement of at least one internal physical condition of said apparatus, wherein the monitored internal physical condition is selected from the group consisting of an internal temperature of said apparatus and an internal pressure of said apparatus,

20. An apparatus for microfiltering milk, said apparatus comprising:
at least one milking attachment configured for attachment to a milk producing organism and configured for milking said milk producing organism;
at least one milk microfilter configured to microfilter milk,
at least one pump configured to pump milk from the milking attachment through the milk microfilter and to an exit location of said apparatus through at least one transport conduit;
wherein the milking attachment, the milk microfilter, and the pump are positioned and configured such that milk is pumped by the pump from the milking apparatus through the milk microfilter while the milk is at a temperature approximate to a body temperature of an organism being milked and from the milk microfilter to the exit location;
at least one milk warming device configured for maintaining said milk at said temperature approximate to the body temperature of an animal that produced said milk until said milk is microfiltered;
at least one milk cooling device positioned and configured for cooling said milk after said milk is filtered; and
at least two internal condition monitoring devices positioned and configured for providing a measurement of at least one internal physical condition of said apparatus, wherein said internal physical condition is selected from the group consisting of an internal temperature of said apparatus and an internal pressure of said apparatus, wherein at least one of said internal condition monitoring devices is positioned at a point of said apparatus between said milking attachment and said milk microfilter, wherein at least one of said internal condition monitoring devices is positioned at a point of said apparatus between said milk microfilter and said exit location, wherein said internal condition monitoring devices are positioned and configured such that said measurements produced by said internal condition monitoring devices can be monitored to determine the performance of said apparatus.
